(19) United States
(12) Patent Application Publication
(10) Pub. No.: US 2014/0181415 A1
(43) Pub. Date: Jun. 26, 2014

(54) PREFETCHING FUNCTIONALITY ON A LOGIC DIE STACKED WITH MEMORY

(71) Applicant: ADVANCED MICRO DEVICES, INC., Sunnyvale, CA (US)

(72) Inventors: Gabriel Loh, Bellevue, WA (US); Nuwan Jayasena, Sunnyvale, CA (US); James O'Connor, Austin, TX (US); Michael Schulte, Austin, TX (US); Michael Ignatowski, Austin, TX (US)

(73) Assignee: ADVANCED MICRO DEVICES, INC., Sunnyvale, CA (US)

(21) Appl. No.: 13/723,285

(22) Filed: Dec. 21, 2012

(51) Int. Cl. G06F 12/08

(52) U.S. Cl. CPC G06F 12/0862
USPC 711/137

(57) ABSTRACT

Prefetching functionality on a logic die stacked with memory is described herein. A device includes a logic chip stacked with a memory chip. The logic chip includes a control block, an in-stack prefetch request handler and a memory controller. The control block receives memory requests from an external source and determines availability of the requested data in the in-stack prefetch request handler. If the data is available, the control block sends the requested data to the external source. If the data is not available, the control block obtains the requested data via the memory controller. The in-stack prefetch request handler includes a prefetch controller, a prefetcher and a prefetch buffer. The prefetcher monitors the memory requests and based on observed patterns, issues additional prefetch requests to the memory controller.

### TECHNICAL FIELD

The disclosed embodiments are generally directed to memory.

### BACKGROUND

Memory systems can be implemented using multiple silicon chips within a single package. For example, memory chips can be three-dimensionally integrated with a logic and interface chip. The logic chip and interface can include functionality for interconnect networks, built-in self test, and memory scheduling logic. These memory systems provide a simple interface that allows clients to read or write data from or to the memory, along with a few other commands specific to memory operation, (for example, refresh or power down). These multi-chip integrated memories will be shared by a number of sharers, whether in terms of threads, processes, cores, processors/sockets, nodes, virtual machines (VMs) or other clients like network interface controllers (NICs) or graphics processing units (GPUs) that may require arbitration of access to the multi-chip integrated memory.

### SUMMARY OF EMBODIMENTS

Prefetching functionality on a logic die stacked with memory is described herein. In some embodiments, a device includes a logic chip stacked with a memory chip. The logic chip includes a control block, an in-stack prefetch request handler and a memory controller. The control block receives memory requests from an external source and determines availability of the requested data in the in-stack prefetch request handler. If the data is available, the control block sends the requested data to the external source. If the data is not available, the control block obtains the requested data via the memory controller. The in-stack prefetch request handler includes a prefetch controller, a prefetcher and a prefetch buffer. The prefetcher monitors the memory requests and based on observed patterns, issues additional prefetch requests to the memory controller.

### BRIEF DESCRIPTION OF THE DRAWINGS

A more detailed understanding may be had from the following description, given by way of example in conjunction with the accompanying drawings wherein:

FIG. 1 is an example high level block diagram of a logic chip integrated with a memory stack in accordance with some embodiments;

FIG. 2 is example detailed block diagram of a logic chip integrated with a memory stack in accordance with some embodiments;

FIG. 3 is an example flowchart for prefetching using the embodiment of FIG. 2 in accordance with some embodiments; and

FIG. 4 is a block diagram of an example device in which one or more disclosed embodiments may be implemented.

### DETAILED DESCRIPTION

Most memory chips implement all memory storage components and peripheral logic and circuits, (e.g., row decoders, input/output (I/O) drivers, test logic), on a single silicon chip. Implementing additional logic directly in the memory is expensive and has not proven to be practical because the placement of logic in this type of memory chip incurs significant costs in the memory chips, and the performance is limited due to the inferior performance characteristics of the transistors used in memory manufacturing processes.

Memory systems can be implemented using one or more silicon chips within a single package. These memory chip(s) split the memory cells on to one or more silicon chips, and the logic and circuits, (or a subset of the logic and circuits), on to one or more separate logic chips. The separate logic chip(s) can be implemented with a different fabrication process technology that is better optimized for power and performance of the logic and circuits. The process used for memory chips is optimized for memory cell density and low leakage and the circuits implemented on these memory processes have very poor performance. The availability of a separate logic chip(s) provides the opportunity to add value to the memory system by using the logic chip(s) to implement additional functionality. The terms memory chip, logic chip, and logic and interface chip and the terms memory chips, logic chips, and logic and interface chips are used interchangeably to refer to at least one memory chip, logic chip, and logic and interface chip, respectively.

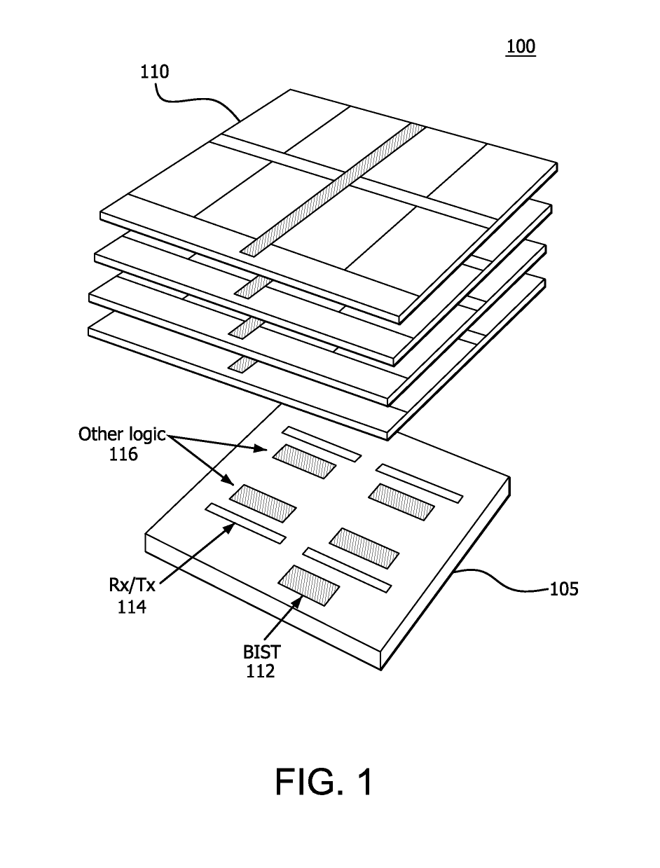

FIG. 1 shows an example high level block diagram of a multi-chip integrated memory 100 that includes a logic and interface chip 105 and multiple memory chips 110. The memory chips 110 are, for example, three-dimensionally integrated with the logic and interface chip 105. The logic and interface chip 105 can include functionality for built-in self test 112, transmit and receive logic 114 and other logic 116, for example, for interconnect networks and memory scheduling.

Described herein are memory chips integrated or stacked with a logic chip that includes prefetching functionality or capabilities to perform aggressive prefetching within the stack. This may be referred to herein as in-stack prefetching. Normally, overly aggressive prefetching from memory can waste power and bandwidth. In particular, conventional central processing unit (CPU)-side prefetchers cannot prefetch very aggressively, because doing so would consume too much memory bandwidth. The CPU-to-memory interface across the printed circuit board (PCB) or interposer consumes significant energy to operate and has limited bandwidth. This costs significant power, and can hurt performance by reducing the amount of available bandwidth for non-prefetch (demand and write back) requests. Moreover, the average time to access memory may increase without appropriate prefetch mechanisms.

The interface between the logic chip and the memory chip(s) provides much higher bandwidth and reduced energy. More aggressive prefetching from the memory chips to quickly accessible prefetch buffer(s), (limited to within the stack), can be utilized to improve performance. Implementing prefetch mechanisms in the logic chip of a multi-chip memory system can directly improve performance, reduce bandwidth requirements and reduce energy and/or power consumption. Furthermore, this prefetching can take into account requests from multiple sharers of the memory. Providing prefetching mechanisms in the logic chip of a multi-chip integrated memory provides flexibility in determining how the memory will be used and shared among sharers. It also improves performance and power relative to implementing prefetching directly in the CPU or other sharer.

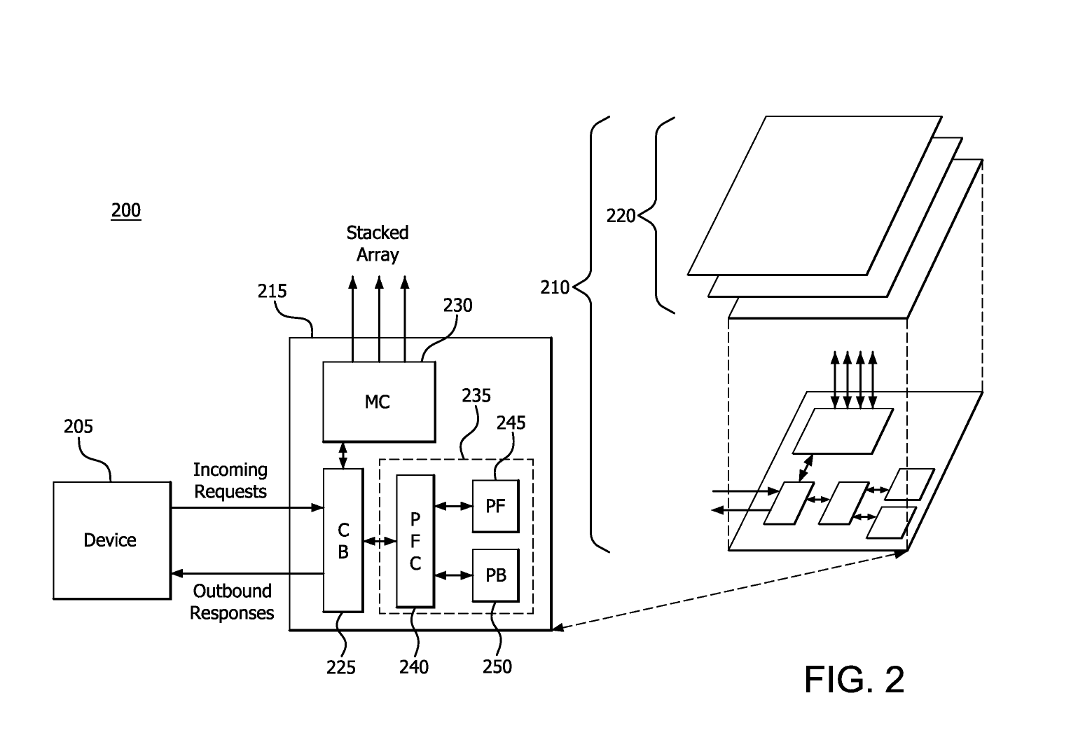

FIG. 2 is example block diagram of a system 200 including a device 205 that requests and receives data from a memory system 210 in accordance with some embodiments. The device 205 may be, but is not limited to, a CPU, graphics processing unit (GPU), accelerated processing unit (GPU), digital signal processor (DSP), field-programmable gate array (FPGA), application specific integrated circuit (ASIC) and any other component of a larger system that communicates with the memory system 210. In some embodiments, the device 205 may be multiple devices accessing the same memory system 210. The memory system 210 includes a logic and interface chip 215 integrated with a memory stack 220. The logic chip prefetch implementation is applicable for different memory technologies including, but not limited to, dynamic random access memory (DRAM), static RAM (SRAM), embedded RAM (eDRAM), phase change memory (PCM), memristors, spin transfer torque magnetic random access memory (STT-MRAM), or the like.

The logic chip 215 includes a control block (CB) 225 connected to a memory controller (MC) 230 and an in-stack prefetch request handler 235. The MC 230 is connected to and interfaces with the memory stack 220. The in-stack prefetch request handler 235 includes a prefetch controller (PFC) 240 that is connected to a prefetcher (PF) 245 and a prefetch buffer (PB) 250. The PF 245 may be a hardware prefetcher. The PB 250 may be, but is not limited to, a SRAM array, any other memory array technology, or a register.

The CB 225 receives all incoming memory requests to the memory stack 220 from the device 205. The requests are sent to the PF 245, (for example, next-line, stride, and the like) via the PFC 240. The PF 245 monitors the incoming memory requests and based on observed patterns, issues additional prefetch requests to the MC 230. Prefetched data are placed into the PB 250. The CB 225 also checks any incoming memory requests against the data in the PB 250. Any hits can be served directly from the PB 250 without going to the MC 230. This reduces the service latencies for these requests, as well as reducing contention in the MC 230 of any remaining requests, (i.e., those that do not hit in the PB 250).

The PF 245 may encompass any prefetching algorithm/method or combination of algorithms/methods. Due to the row-buffer-based organization of most memory technologies, (for example, DRAM), prefetch algorithms that exploit spatial locality, (for example, next-line, small strides and the like), have relatively low overheads because the prefetch requests will (likely) hit in the memory's row buffer(s). Implementations may issue prefetch requests for large blocks of data, (i.e., more than one 64B cache line's worth of data), such as prefetching an entire row buffer, half of a row buffer, or other granularities.

In an embodiment, the PF 245 can also be used to implement software prefetching, in which the memory request contains explicit information regarding which data to prefetch. For example, when accessing an array in sequential (strided) order, a prefetch request could indicate that multiple sequential (strided) blocks should be prefetched from memory.

In another embodiment, in addition to exploiting spatial locality, the PF 245 can also implement indirect prefetching, (i.e., using the address sent to memory as a pointer to the data to prefetch), to improve the performance of applications that implement pointer chasing.

The PB 250 may be implemented as a direct-mapped, set-associative, to a fully-associative cache-like structure. In an embodiment, the PB 250 may be used to service only read requests, (i.e., writes cause invalidations of prefetch buffer entries, or a write-through policy must be used). In another embodiment, the PB 250 may employ replacement policies such as Least Recently Used (LRU), Least Frequency Used (LFU), or First In First Out (FIFO). If the prefetch unit generates requests for data sizes larger than a cache line, (as described hereinabove), the PB 250 may also need to be organized with a correspondingly wider data block size. In some embodiments, sub-blocking may be used.

In some embodiments, the memory requests sent to the MC 230 may be marked as coming from the device 205, (i.e., from a CPU or another sharer), or as coming from the in-stack prefetch request handler 235. This allows the MC 230 to prioritize (likely) more critical requests from the device 205, (or other sharers), than the more speculative requests from the in-stack prefetch request handler 235. This may be particularly important, because the in-stack prefetch request handler 235 may be quite aggressive, (i.e., generates many requests), which could cause significant contention in the MC 230. By distinguishing the requests, the MC 230 can still service the requests from the device 205 (or other sharers) relatively quickly even in the presence of a large number of prefetch requests from the in-stack prefetch request handler 235. In some embodiments, the MC 230 will have the ability to promote the priority of a prefetch request to that of a more critical request whenever the MC 230 receives a request for that data from the device 205 (or other sharers) after a pending prefetch for that data has been issued but not yet serviced.

In another embodiment, there is a “cancellation” interface from the MC 230 back to the in-stack prefetch request handler 235. If the MC 230 receives too many overall requests and cannot satisfy the in-stack prefetch request handler 235 requests in a timely fashion, (or the prefetch requests are consuming too many MC 230 request buffer entries), the MC 230 may choose to simply drop or ignore one or more prefetch requests. Upon doing so, the corresponding memory controller request buffer(s) is made free for another request to use, and a cancellation signal is sent back to the in-stack prefetch request handler 235 to notify it that (a) the prefetch request will not be completed, and (b) that the in-stack prefetch request handler 235 may be overly aggressive and should back off. In an example method, the MC 230 may drop prefetch requests if the MC 230 request buffer is full. In another example, the MC 230 may drop prefetch requests if a predetermined percentage of the MC 230 request buffer is full.

Conventional hardware prefetchers make requests at the granularity of individual cache lines, (e.g., 64B blocks). Due to the increased available bandwidth between the logic chip 215 and the memory chips 220 of the stacked implementation, embodiments may include more aggressive hardware prefetchers that prefetch data at larger granularities, (e.g., 128B, 256B or more at a time). The requested data may come from consecutively addressed locations, and/or they may come from non-sequentially-addressed locations, (e.g., from different memory channels and/or banks).

Some embodiments may implement “pre-activation” or “pre-precharging” in addition to or instead of the data prefetching functionality described. The prefetching logic may use policies or predictive structures to determine that a particular memory page, (for example, a DRAM page), is no longer likely to be referenced, and issue a precharge for the page. Similarly, activation for a given row can be predicted. Timely and accurate prediction of these events can improve memory access latencies, even in the absence of prefetching the data into the PB 250.

While FIG. 2 illustrates a single CB 225, MC 230, and in-stack prefetch request handler 235, embodiments may include a plurality of any of the above units. For example, multiple PFs implementing different prefetch algorithms may be desired. Multiple MC's may be used to control and interface with different memory channels in the memory stack. Some embodiments may implement CB's, PF's and PB's on a per-channel basis to reduce implementation complexity. Other embodiments may prefer centralized structures, (PF's and PB's in particular), to reduce the effects of storage fragmentation, (e.g., in a distributed or per-channel implementation, one PB may be over-utilized while a PB associated with a different channel is underutilized). Embodiments may mix and match in that some structures could be implemented on a per-channel basis, (or other organizations involving a plurality of the structures), while other structures may be implemented in a more centralized/shared manner.

The circuits implementing and providing the prefetching and prefetch buffer/cache functionality may be realized through several different implementation approaches. For example, in one embodiment, the prefetching functionality may be implemented in hard-wired circuits. In another embodiment, the prefetching functionality may be implemented with programmable circuits or a logic circuit with at least some programmable or configurable elements.

While described herein as being employed in a memory organization consisting of one logic chip and one or more memory chips, there are other physical manifestations. Although described as a vertical stack of a logic chip with one or more memory chips, another embodiment may place some or all of the logic on a separate chip horizontally on an interposer or packaged together in a multi-chip module (MCM). More than one logic chip may be included in the overall stack or system.

In another embodiment, systems incorporating the memory system with the in-stack prefetch request handler may extend the request interface to the memory stack to enable optimized operation of the in-stack prefetch logic. In general, these extensions permit additional information to be sent from the requesting device to the memory stack. These extensions may include, but are not limited to, tagging each request with a “requestor ID”, which may identify for example a specific CPU or other unit or component within the system where the request originated. The in-stack prefetcher may then extract access patterns for each requestor more effectively and improve prefetch effectiveness.

Another extension may include support for cooperative operation between device-side, (for example, CPU-side), and in-stack prefetchers where the requests may include hints to the in-stack prefetchers. This may be as simple as tagging requests generated by device-side prefetchers with a bit to indicate their speculative nature or a degree of probability associated with the prefetch request, (which can therefore be factored into the analysis performed by in-stack prefetchers), or as complex as issuing explicit directives to the in-stack prefetchers.

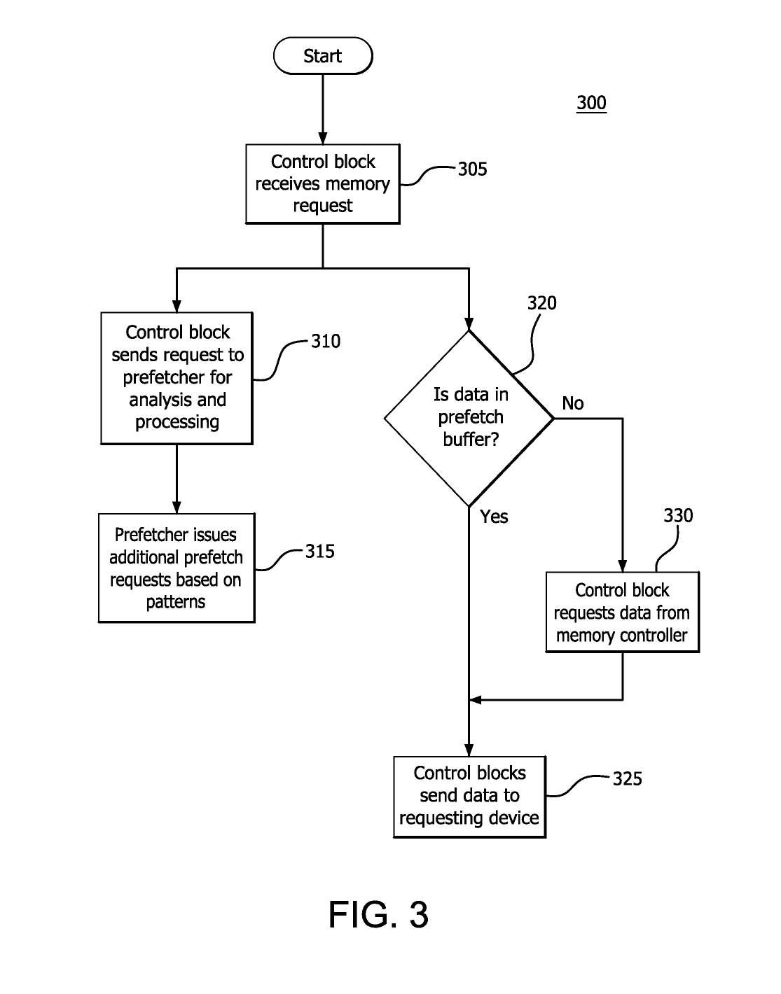

FIG. 3 is an example high level flowchart 300 for in-stack prefetching. A requesting device sends a memory request to a control block in the memory system (305). The control block sends the memory request to the prefetcher which monitors all incoming memory requests (310) and issues additional prefetch requests to the memory controller via the control block (315). The control block also checks the memory request against the data in the prefetch buffer (320). If the data is present in the prefetch buffer, then the control blocks handles the memory request without additional assistance of the memory controller and sends the requested data to the requesting device (325). If the data is not present, the control block requests the data via the memory controller from memory stack (330) and sends the data back to the requesting device upon receipt from the memory controller (325).

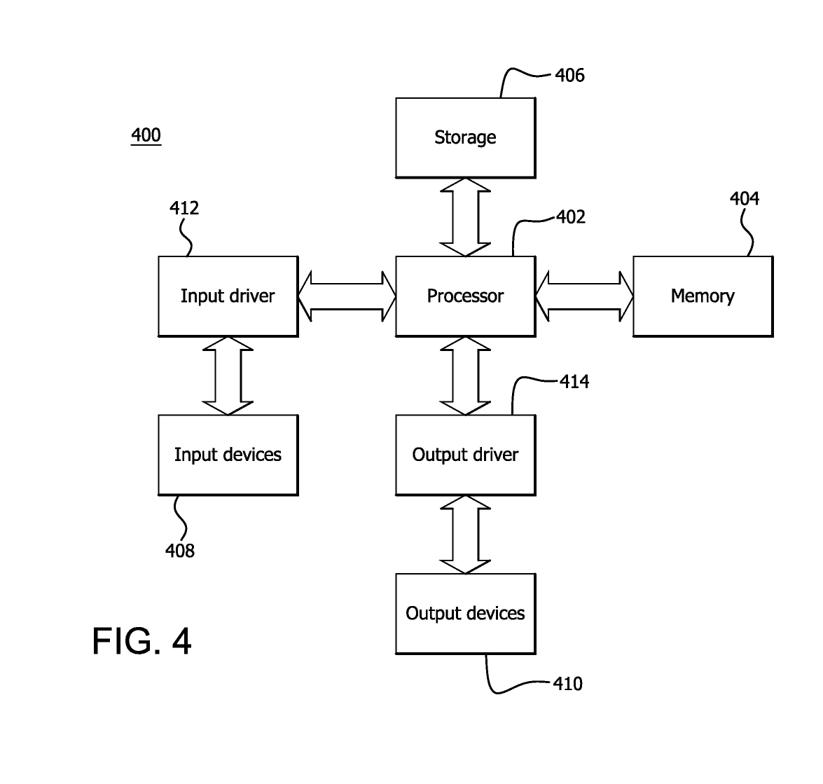

FIG. 4 is a block diagram of an example device 100 in which one or more disclosed embodiments may be implemented. The device 100 may include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 may also optionally include an input driver 112 and an output driver 114. It is understood that the device 100 may include additional components not shown in FIG. 1.

The processor 102 may include a central processing unit (CPU), a graphics processing unit (GPU), a CPU and GPU located on the same die, or one or more processor cores, wherein each processor core may be a CPU or a GPU. The memory 104 may be located on the same die as the processor 102, or may be located separately from the processor 102. The memory 104 may include a volatile or non-volatile memory, for example, random access memory (RAM), dynamic RAM, or a cache.

The storage 106 may include a fixed or removable storage, for example, a hard disk drive, a solid state drive, an optical disk, or a flash drive. The input devices 108 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 may include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

In general, in some embodiments, a memory system includes at least one logic chip stacked with at least one memory chip. The logic chip including a control block that is connected to an in-stack prefetch request handler and a memory controller. The control block receives memory requests from a device and determines the availability of the requested data in the in-stack prefetch request handler. The control block sends the requested data to the device if the data is available in the in-stack prefetch request handler. Otherwise, the control block obtains the requested data from the memory controller upon non-availability of the requested data in the in-stack prefetch request handler. The in-stack prefetch request handler includes a prefetch controller connected to the control block, a prefetcher and a prefetch buffer. The prefetcher monitors the memory requests and based on observed patterns, issue additional prefetch requests to the memory controller and the prefetch buffer stores prefetched data.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods or flow charts provided herein, to the extent applicable, may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A memory system, comprising:
at least one memory chip;
at least one logic chip stacked with the at least one memory chip;
the at least one logic chip including a control block that is connected to an in-stack prefetch request handler and a memory controller, wherein the control block is configured to receive memory requests from at least one device;
the control block configured to determine availability of requested data in the in-stack prefetch request handler;
the control block configured to send the requested data to a device upon availability in the in-stack prefetch request handler; and
the control block configured to obtain the requested data from the memory controller upon non-availability of the requested data in the in-stack prefetch request handler.

2. The memory system of claim 1, wherein the in-stack prefetch request handler further comprises:
a prefetch controller connected to the control block, a prefetcher and a prefetch buffer;
the prefetcher configured to monitor the memory requests and based on observed patterns, issue additional prefetch requests to the memory controller; and
the prefetch buffer configured to store prefetched data.

3. The memory system of claim 1, wherein the memory request includes instructions to prefetch specified data.

4. The memory system of claim 1, wherein the prefetcher is configured to employ at least one of spatial locality and indirect prefetching.

5. The memory system of claim 1, wherein the prefetch buffer is configured to service only read requests.

6. The memory system of claim 1, wherein the memory requests are identified as coming from the device or the in-stack prefetch request handler.

7. The memory system of claim 1, wherein the memory controller is configured to prioritize the memory requests based on origin from the device or the in-stack prefetch request handler.

8. The memory system of claim 1, wherein the memory controller is configured to re-prioritize pending memory requests based on a second memory request for identical data.

9. The memory system of claim 1, wherein the memory controller is configured to cancel prefetch requests due to a predetermined number of prefetch requests.

10. The memory system of claim 9, wherein the memory controller is configured to signal the in-stack prefetch request handler to decrease number of prefetch requests.

11. The memory system of claim 1, wherein the in-stack prefetch request handler is configured to prefetch data at least one cache line at a time.

12. The memory system of claim 1, wherein the memory controller includes multiple memory controllers interfaced over different memory channels in the at least one memory chip.

13. The memory system of claim 12, wherein the control block includes multiple control blocks and the control blocks, the prefetchers, and multiple prefetch buffers operate on a per-memory channel basis.

14. The memory system of claim 1, wherein the in-stack prefetch request handler includes multiple prefetchers that are configured to employ different prefetching algorithms.

15. The memory system of claim 1, wherein the at least one logic chip and the at least one memory chip are stacked via at least one of a horizontal stack or a vertical stack.

16. The memory system of claim 1, wherein the memory request includes identification of requestor.

17. The memory system of claim 1, wherein the memory request includes tags to indicate degree of probability of prefetch request.

18. A method for prefetching data, comprising:
receiving a memory request at a control block from a device, the control block located on a logic die stacked with memory;
determining, by the control block, availability of requested data in an in-stack prefetch request handler located on the logic die;
sending the requested data to the device upon availability in the in-stack prefetch request handler; and
obtaining the requested data from a memory controller upon non-availability of the requested data in the in-stack prefetch request handler, the memory controller being located on the logic die.

19. The method of claim 18, further comprising:
monitoring, by a prefetcher, of the memory requests and based on observed patterns, issuing additional prefetch requests from the memory controller, the prefetcher being part of the in-stack prefetch request handler.

20. The method of claim 18, wherein the memory request includes at least one of instructions to prefetch specified data, identification of requestor and tags to indicate degree of probability of prefetch request.

21. The method of claim 18, wherein the memory requests are identified as coming from the device or the in-stack prefetch request handler.

22. The method of claim 18, further comprising:
prioritizing the memory requests based on origin from the device or the in-stack prefetch request handler;
re-prioritizing pending memory requests based on a second memory request for identical data;
canceling prefetch requests due to a predetermined number of prefetch requests;
signaling the in-stack prefetch request handler to decrease number of prefetch requests.

23. The method of claim 18, wherein the in-stack prefetch request handler is configured to prefetch data at least one cache line at a time.

24. A device, comprising:
at least one memory chip;
at least one logic chip stacked with the at least one memory chip;
the at least one logic chip including a control block, an in-stack prefetch circuit and a memory controller;
the control block configured to determine requested data availability in the in-stack prefetch circuit;
the control block configured to send the requested data upon availability; and
the control block configured to obtain the requested data from the memory controller upon non-availability.

25. The device of claim 24, wherein the in-stack prefetch circuit includes a prefetcher configured to monitor the memory requests and based on observed patterns, issue additional prefetch requests to the memory controller.

26. The device of claim 24, wherein the memory request includes at least one of instructions to prefetch specified data, identification of requestor and tags to indicate degree of probability of prefetch request.

27. The device of claim 24, wherein the memory requests are identified as coming from an external source or the in-stack prefetch request handler.

28. The device of claim 24, wherein:
the memory controller is configured to prioritize the memory requests based on origin from an external source or the in-stack prefetch request handler; and
the memory controller is configured to re-prioritize pending memory requests based on a second memory request for identical data.

29. The device of claim 24, wherein:
the memory controller is configured to cancel prefetch requests due to a predetermined number of prefetch requests and
the memory controller is configured to signal the in-stack prefetch request handler to decrease number of prefetch requests.

30. The device of claim 24, wherein the in-stack prefetch request handler is configured to prefetch data at least one cache line at a time.
